(19) United States
(12) Patent Application Publication
(10) Pub. No.: US 2005/0188199 A1
(43) Pub. Date: Aug. 25, 2005

(54) Securing computer data

(76) Inventors: Hoke Smith, Dallas, TX (US); L. Michael Mints, Fairview, TX (US)

Correspondence Address: CARR LLP, 670 FOUNDERS SQUARE, 900 JACKSON STREET, DALLAS, TX, 75202, US

(21) Appl. No.: 11/062,079

(22) Filed: Feb. 21, 2005

Related U.S. Application Data
(60) Provisional application No. 60/546,237, filed on Feb. 20, 2004.

(51) Int. Cl. H04L 9/00

(52) U.S. Cl. 713/165

(57) ABSTRACT

One aspect of the present invention provides a method and a system for securing data and transmitting it securely. Data is encrypted on a source computer and transmitted to a receiving computer. Users must provide authentication to access the data on the source or receiving computer. The data is not decrypted on the receiving computer until access to it has been authorized. The data can be viewed on the receiving computer or processed to create a print file. The print file can be printed onto pre-printed or partially pre-printed forms. A second aspect of the present invention provides a method for dividing a data file into portions and encrypting the portions. Not all of the portions are encrypted by the same encryption method. An index file describes the portions into which the data was divided and the methods of encryption used to encrypt the portions. The different encryption methods can use different keys. These keys can be produced by multiplying an encryption key by random numbers.

### CROSS-REFERENCE TO RELATED APPLICATIONS

This application relates to, and claims the benefit of the filing date of, co-pending U.S. provisional patent application Ser. No. 60/546,237 entitled “Secure Payroll Distribution” filed on Feb. 20, 2004.

### TECHNICAL FIELD

The present invention relates generally to securing computer data.

### BACKGROUND

The present methods for transmitting data to computers in remote locations and for providing both original and secure copies of documents to remote locations are inefficient, time-consuming, insecure and expensive. As examples, payroll checks, health insurance documents (under HIPAA and otherwise), government records, licenses, permits, titles and a variety of other documents are typically created via centralized printing, signatures are affixed (if needed), and the documents are then distributed via actual physical delivery. This is costly and time-consuming, and maintaining records regarding access, use and chain-of-custody is difficult. As just one example, some companies now print payroll checks at remote locations using MICR toner (special toner high in iron oxide that can produce charged images for the account number and routing number) readable by charged scanner-readers. However, this method lacks many security features, and the capital investment needed for the related, dedicated equipment is expensive—especially as the specialized MICR printing application is only needed part time. Finally, record-keeping and chain of custody abilities inherent in all the above methods are limited. For example, a system may create a transaction number for the printing of a particular document, but the number references only a limited amount of information, such as the number of documents in a sequence that have been produced during a given duration.

Conventional encryption algorithms, such as DES and AES, may be employed that are capable of providing multiple levels of encryption to an entire document or file. This is accomplished by successively encrypting a file or document, such as by encrypting the entire file using a first key, then in turn encrypting the entirety of the resulting encrypted file using a second key, and so on, in successive encrypting steps that produce multiple levels of encryption and security for the entire file or document. This process will be referred to as successive encryption. These conventional algorithms, however, employ the same method and provide the same level of security to the entire document or file.

Therefore, an improved method is needed for the secured transmission of data to computers in remote locations, the secure viewing of the data and the secure printing of documents incorporating the data-one that eliminates the need for specialized supplies and equipment, such as MICR toner and related specialized equipment, provides for complete record keeping, allows the use of partially pre-printed forms, and provides great flexibility of application. Further, an improved method of encryption is needed that can provide various degrees of encryption and security to different portions of a file or document, as desired.

### SUMMARY OF THE INVENTION

One aspect of the present invention provides a method and a system for securing computer data and transmitting it securely. Data is encrypted on a source computer and transmitted to a receiving computer. Users must provide authentication to access the data on the source or receiving computer. The data is not decrypted on the receiving computer until access to it has been authorized.

A second aspect of the present invention provides a method and a system for dividing a data file into portions and encrypting the portions. Not all of the portions are encrypted by the same encryption method. An index file describes the portions into which the data was divided and the methods of encryption used to encrypt the portions.

### BRIEF DESCRIPTION OF THE DRAWINGS

For a more complete understanding of the present invention and the advantages thereof, reference is now made to the following descriptions taken in conjunction with the accompanying drawing, in which:

FIG. 1 is a block diagram of a system for the secure transmission of data to remote computers;

FIG. 2 is a diagram showing the flow of data through a system for the secure transmission of data to remote computers;

FIG. 3 is a block diagram of a parsing and distribution program;

FIG. 4 is a block diagram of a store program; and

FIG. 5A/5B is a flow diagram of the process of previewing and printing documents incorporating the data from a remote location;

FIG. 6 illustrates the front side of a pre-printed form containing security features; and

FIG. 7 illustrates the back side of a pre-printed form containing security features.

### DETAILED DESCRIPTION

The entire contents of Provisional Patent Application Ser. No. 60/546,237, entitled “Secure Payroll Distribution” filed on Feb. 20, 2004, and the contents of Provisional Patent Application Ser. No. 60/645,394, entitled “Securely Printing of Documents Remotely and Title and Registration Automated System (TRAS)” filed on Jan. 19, 2005, are incorporated herein by reference for all purposes.

In the following discussion, specific details are set forth to provide a thorough understanding of the present invention. However, it will be apparent to those skilled in the art that the present invention may be practiced without such specific details. In other instances, well-known elements have been illustrated in schematic or block diagram form in order not to obscure the present invention in unnecessary detail.

It is further noted that, unless indicated otherwise, all functions described herein may be performed by either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

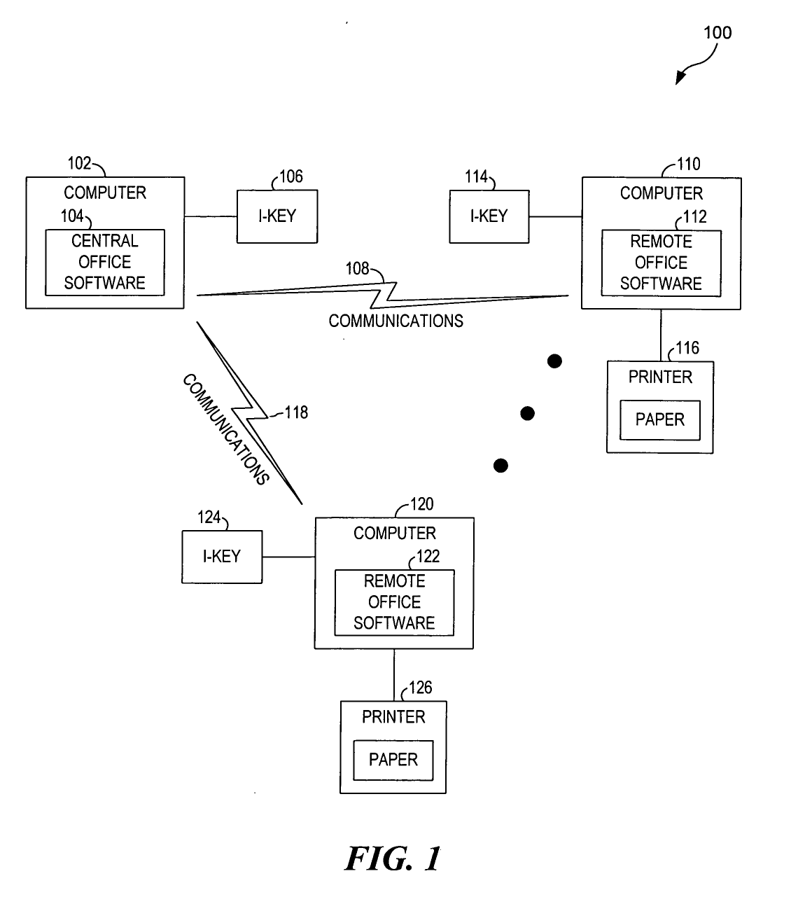

Referring now to FIG. 1, reference numeral 100 generally indicates a block diagram of a system for the secure transmission of data to remote computers. A central office computer 102 is connected to remote computers 110 and 120 over communications links 108 and 118. The ellipsis between the remote computers 110 and 120 indicates that there can be more than two remote computers. In addition, in other embodiments, multiple central office computers may be employed, in one or multiple locations. The communications links 108 and 118 can be any form of communications including, but not limited to the Internet, dial-up/ISDN (Integrated Services Digital Network)/DSL, frame relay, VPN (Virtual Private Network), satellite, microwave, fiber-optic, wireless and other suitable communications links and/or channels. Thus, a business or other entity can utilize existing communications methods. In this embodiment, the central office computer 102 runs central office software 104, and the remote computers 110 and 120 run copies of the remote office software 112 and 122. The printers 116 and 126 are connected to the remote computers 110 and 120 respectively.

To access the system, a user at any location must provide authentication. In this embodiment, he must login with a proper login and password. In addition, he must present a USB key to the system for recognition. A USB key is a device that contains a smart chip (mini-version of microprocessor and memory) and plugs into a USB port. The memory contains a digital certificate which is used to identify a user. Verification can be tied to a particular computer and individual. This embodiment uses an iKey, a version of a USB key manufactured by SafeNet, 4690 Millennium Drive, Belcamp, Md. 21017. In FIG. 1, a user at the central office has inserted his iKey 106 and users at the remote locations have inserted their iKeys 114 and 124 respectively. Other embodiments can use other authentication devices including but not limited to smartcards and biometric devices such as fingerprint scanning and iris scanning. In other embodiments, one or more authentication procedures must be performed before accessing the system.

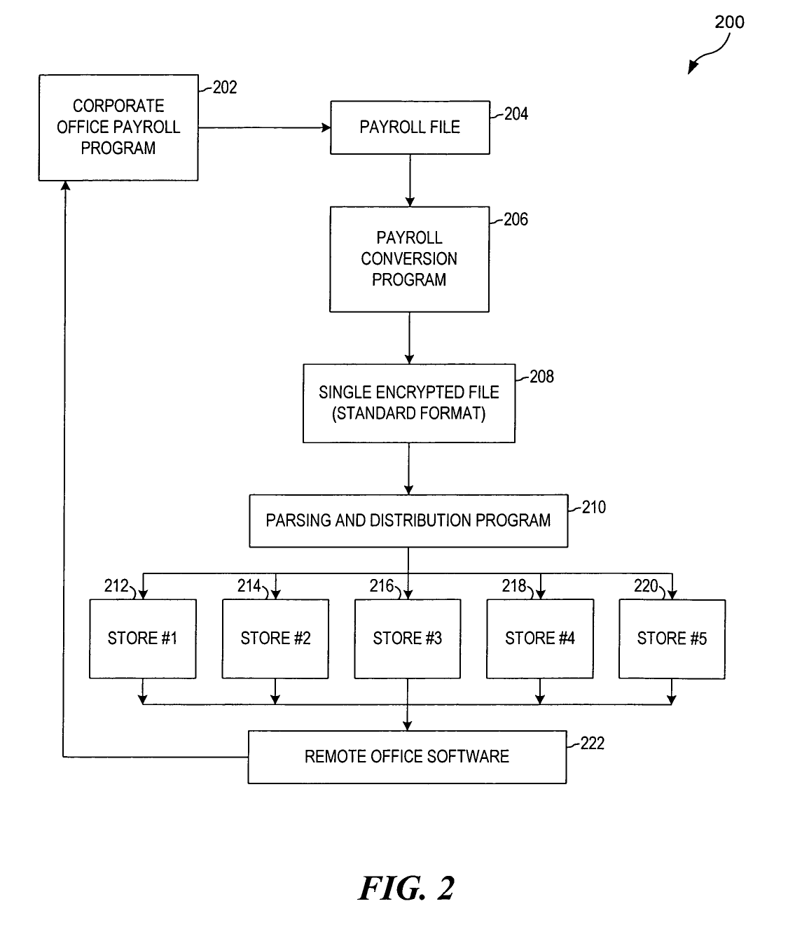

Referring now to FIG. 2, reference numeral 200 generally indicates a diagram showing the flow of data through a system for the remote printing of documents securely. In an embodiment used to print payroll checks, a corporate office payroll program 202 generates data for a payroll. The data is sent to a payroll file 204. The payroll file 204 is then converted by a payroll conversion program 206, a component of the central office software 104, into an encrypted file or files 208. Similarly, in other embodiments, the data files needed to produce the desired documents are generated. For example, insurance documents would require data about the insured and the payments, and title documents would require information about the owner, financing and insurance. The data files are then converted by the central office software 104 into an encrypted file or files.

The parsing and distribution program 210, another component of the central office software 104, then distributes the data contained in the encrypted file or files 208 to the remote locations, 212 through 220.

In this embodiment, a proprietary encryption algorithm is used to provide various degrees of encryption and security to different portions of a file or document, as desired. The portions of the file are subjected to successive encryption. Different portions of the file are subject to different levels of encryption. An index file describes how to fit the pieces together, and what keys are used for encryption. This index file is itself encrypted. The file remains encrypted while residing on the central office computer 102 and during download to a remote computer 110 or 120. In an embodiment, new keys are produced by multiplying the 3DES key by random numbers, called modifiers. The index file includes the modifier and location-code in the file. An example of an unencrypted index file is as follows:
(//,4,,1/23,,2/354,,3/88,,4/43,//).
   The first sequence, 4, identifies the number of portions to the file, 4. The second, third, fourth and fifth sequences identify each part of the file and the modifier used for that sequence. The beginning and end of the sequence are identified by a double forward-slash. In an embodiment, the index file is decrypted with the iKey number that was used to access the remote software. The parsing and distribution program 210, another component of the central office software 104, then distributes the data contained in the encrypted file or files 208 to the remote locations, 212 through 218. The data can be decrypted and accessed from the remote office software 222.

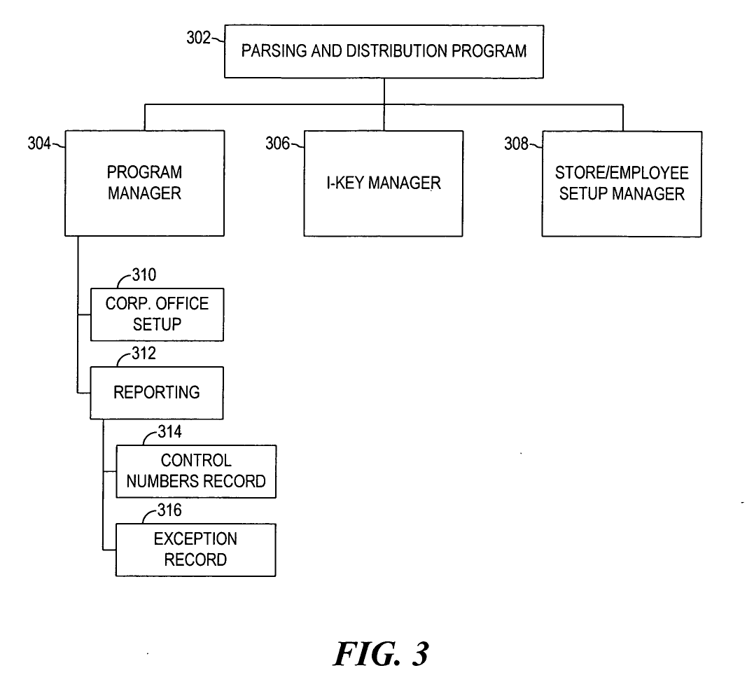

FIG. 3 is a block diagram of a parsing and distribution program 302, a component of the central office software 104. The corporate office setup 310 provides for establishing remote locations and controlling their interaction with the system. The store/employee setup manager 308 provides for granting access to users at the remote locations. Users can be granted differing levels of access. The iKey manager 306 component manages the use of the iKey. It keeps track of the valid digital certificates and controls activation and deactivation of iKey access codes.

The program manager 304 controls the transmission of data files to remote locations. It controls when a data file is transmitted from the central office computer 102 to a remote computer 110 or 120, which computer can download it, and when it is accessible for viewing or printing. The program manager 304 can arrange for periodic transmission of data for regular activities such as payroll, but can also schedule single transmissions at any desired time. The data to govern accessibility and delivery are input by a user as parameters, not hard-coded in. As a result, a user of the central office software has real-time control of the system. He can change these parameters quickly from a central screen, and the changes will take effect throughout the system in a matter of seconds.

The reporting component 312 of the program manager 304 handles reports from the remote locations on the results of printing, successful or unsuccessful. If the printing is successful, the remote location generates transaction identifiers, which are sent to the central office computer and processed by the control number records component 314. A transaction identifier contains detailed information about a document. By processing the transaction identifiers, which are returned by the remote locations, the system can provide a complete audit trail of the documents that are produced. If the printing is not successful, results are processed by the exception records component 316. Exceptions records are created when a document is unable to print or does not print properly.

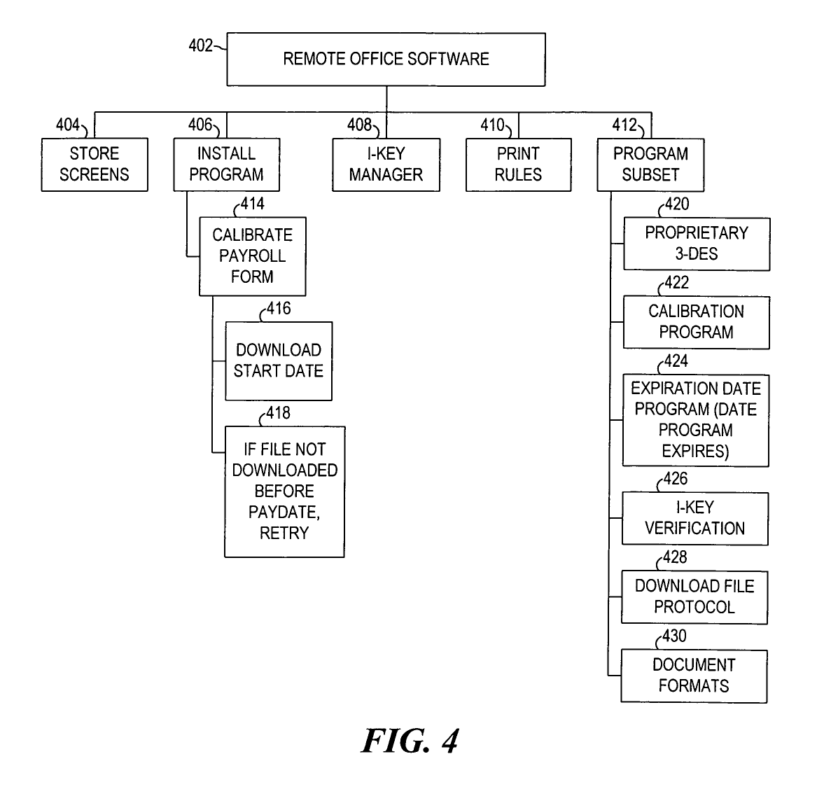

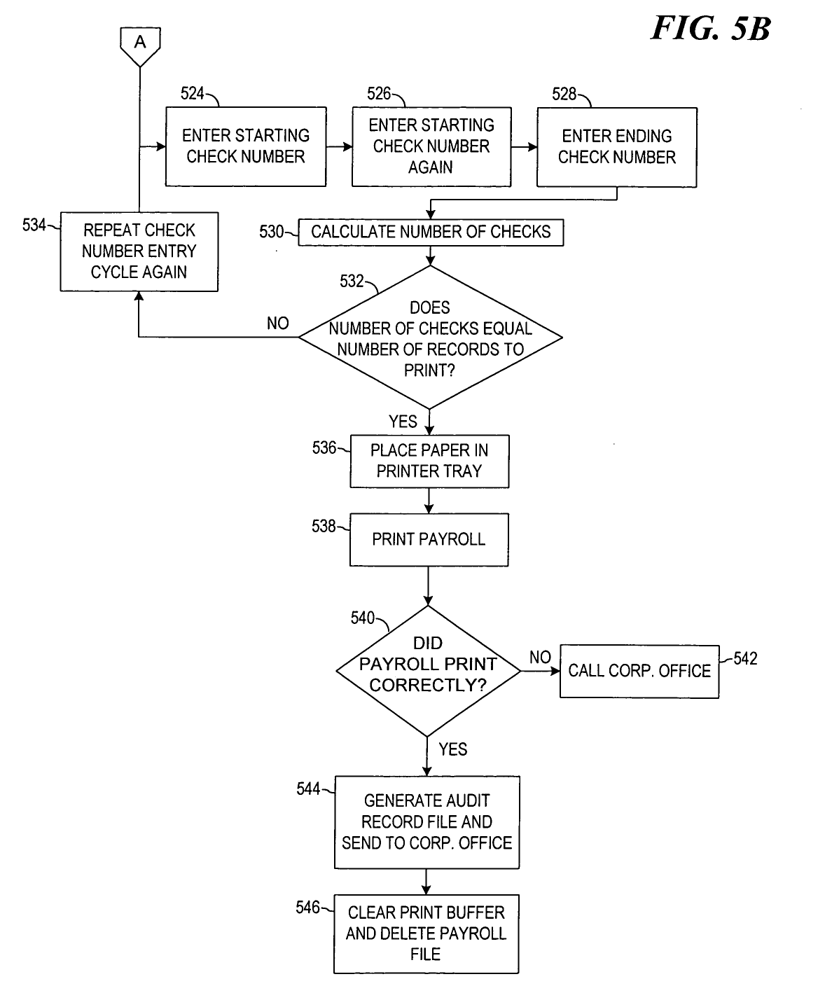

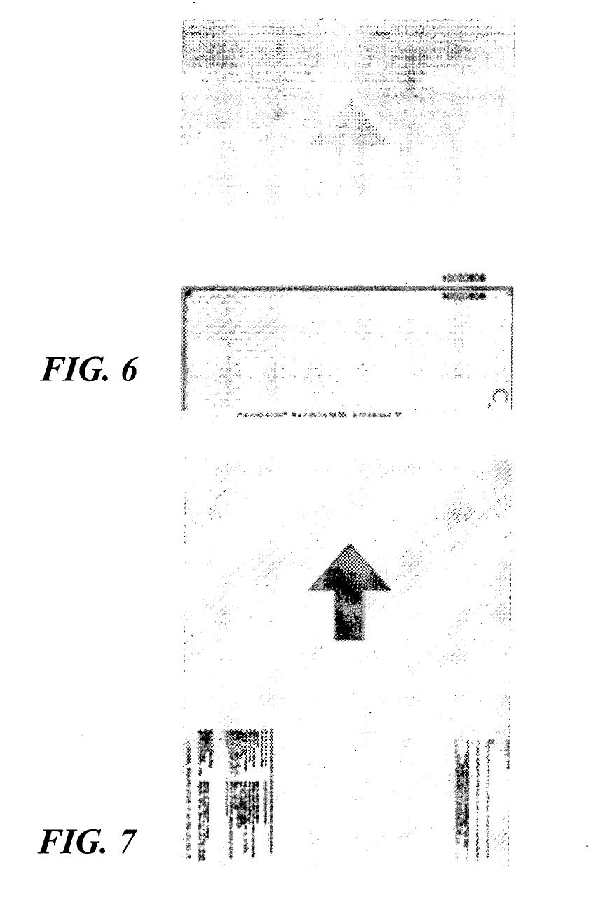

FIG. 4 is a block diagram of remote office software 402. Store screens component 404 controls the screens available to users at a remote computer. Install program 406 component establishes the parameters for the operation of the remote office software 402. The calibrate form component 414 allows for printing onto pre-printed or partially pre-printed forms by describing the format for printing onto those forms. These forms can contain security features that make copying and alteration very difficult. Pre-printed or partially pre-printed forms containing security features will hereafter be called “security paper.” Security features can be pre-printed onto the front or back of a form. The security features that can be pre-printed include, but are not limited to:
(on the front side)
multiple colors and patterns
paper color sensitive to reproduction
chemically sensitive inks
step and repeat pattern
consecutive check numbering
warning band
prismatic printing.
copy-void pantograph
heat-sensitive icon
thermocromatic inks
protected signature area
consecutive and static MICR
check-protect paper with toner grip
high-resolution borders
micro-printing on border and signature line
(on the back side)
original document prismatic image
refractive inks
artificial watermark
paper loading directional arrow
laid lines
protected endorsement area for checks
security legend
protected endorsement area for checks
   FIG. 6 illustrates the front side of a pre-printed form containing security features. FIG. 7 illustrates the back side of a pre-printed form containing security features.

In an embodiment, different combinations of features are used for different types of documents. All of the features are used for checks. There, the first set of features is pre-printed on the front, and the set of features after the blank line are printed on the back. The use of pre-printed checks with the check numbers and routing numbers printed with magnetic ink obviates the need to purchase MICR toner. Other combinations of the above features can be used for the printing of other documents, including, but are not limited to, health insurance documents (under HIPAA and otherwise), government records, licenses, permits, and title documents.

Further security can be provided by printing onto the security paper through software other features which make duplication or alteration difficult. These features include, but are not limited to watermarks, a bar code with the amount of a check, and other features which are difficult or impossible to duplicate, are sensitive to photocopying, or are difficult to alter. In an embodiment, the remote office software incorporates specialized fonts, conversion algorithms, and printing techniques for the printing of these security features.

The download start date component 416 establishes the date that the remote office computer can begin to poll the central office computer for data downloads. It establishes a window of availability for the downloading. For data which is downloaded periodically, such as payroll information, the download start date can be automatically updated for each new set of data. Payroll data can be downloaded the day before each payroll. Component 418 allows a download retry when the data was not available at the download date specified in component 416. The remote computer can force communications with the central office computer and force a download of the data.

The iKey manager component 408 of the remote office software 402 manages the use of the iKeys at the remote level, and has a function similar to component 306 in FIG. 3. Print rules component 410 handles the print protocols, including how long a file is available for printing after it has been transmitted to the remote computer, and the number of attempts to print that can be made. A location can choose a duration of 24 hours for print availability. In an embodiment, only one attempt to print can be made. If it fails, the remote user must call the central office.

The program subset component 412 controls multiple actions of the remote office software 402. The proprietary 3-DES 420 component handles the decrypting of data files. It is tailored to the encryption method. In an embodiment of the invention, the proprietary 3-DES 420 module is tailored to decrypt modules encrypted with a proprietary form of 3-DES. In other embodiments, the proprietary 3-DES 420 component decrypts files encrypted by other methods of encryption. A file remains encrypted in the central office, and during and after transmission to a remote computer. A file on a remote computer is decrypted only when it is accessed for viewing or printing during the time specified in the delivery protocol, if any, and only when it is accessed by an authorized user.

Component 422 calibrates the printing of a form. Component 424 controls the date when the remote office software 402 stops operating. Component 426 reads the iKey to obtain the digital signature contained therein and transmit it to the central office computer for verification. Component 428 controls the communications protocol for downloading files. The system works with a wide variety of communications methods, and the user does not have to change his communications methods in order to utilize this system. Component 430 controls the format of documents that are printed. In an embodiment used for payroll checks, this component controls the format of the paycheck, the messages that are printed on the paycheck, and the format by which the deductions are printed. In other embodiments, used for the printing of other types of documents, other types of formats are controlled. As a result, the system permits printing onto pre-printed or partially pre-printed forms.

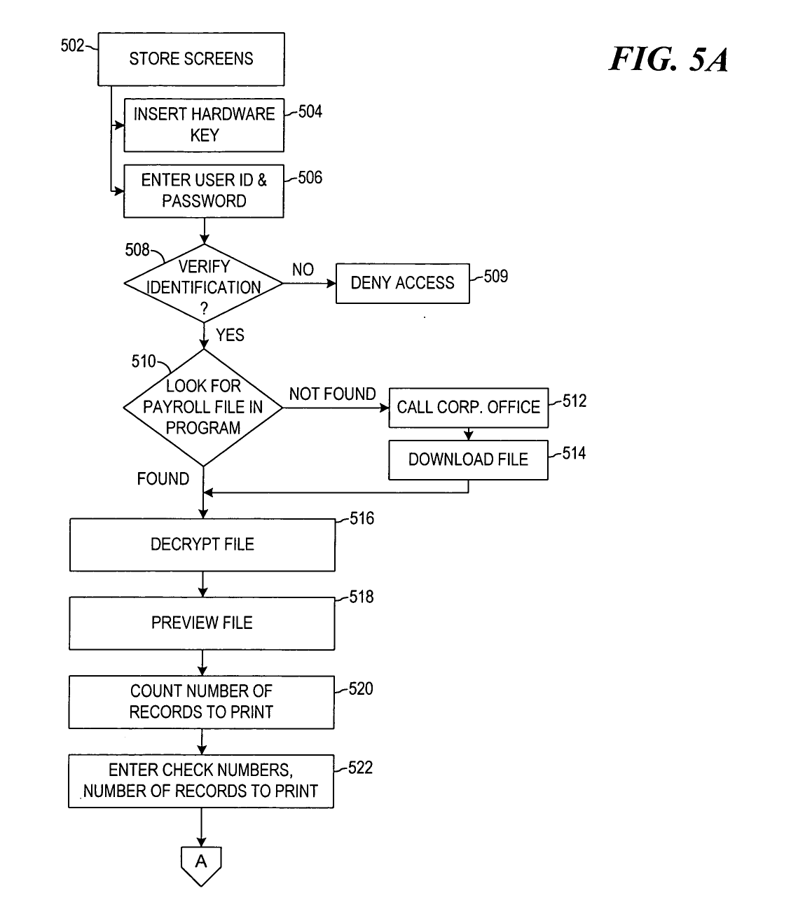

FIG. 5A/5B is a flow diagram of the process of viewing data and printing documents from a remote location. In step 502, a user accesses screens from the remote program. He is requested to provide authentication. In step 504, he inserts his hardware or USB key, the iKey in this embodiment. In step 506, he logs in and gives a password. The identification of the user is verified in step 508. In this embodiment, the user must provide two forms of authentication, the first a login and password and the second an iKey. In other embodiments, the user is required to present at least one form of authentication.

If verification fails, the user is denied access to the program in step 509. If verification succeeds, in step 510 the user searches for the desired data files by using the remote office software (blocks 112 and 122 in FIG. 1). If the files are not found, in step 512 the user calls the central office and in step 514 the files are downloaded. Step 510 is used primarily for periodic printing jobs, when the user knows in advance that the files will be available. It can be omitted for a one-time print job, when the user knows that the files are not available. The user simply calls the central office.

Once the data files have been located on the remote computer, in step 516 they are decrypted. In step 518, the user previews the data files. Next, the user enters a description of the records within the files that he desires to print. In an embodiment of the invention used for payroll, the user counts the number of records to print in step 520. In step 522, he enters the check numbers and the number of records to print. This step is comprised of sub steps 524 through 528. In this application of the invention, the user enters the starting check number twice, in steps 524 and 526, to ensure accuracy. In step 528, he enters the ending check number. In embodiments used for the printing of other types of documents, other methods would be used to specify the records or other portions of the data files to be printed.

In step 530, the remote office software calculates the number of checks. In step 532, it checks whether the number of checks equals the number of records. If no, in step 534, the user reenters the starting and ending numbers. If yes, the user places paper in the printer tray in step 536.

In step 538, the payroll is printed. In other embodiments and other applications of the invention, other types of documents are printed. In step 540, the user checks whether the payroll printed properly. If no, in step 542, the user calls the corporate office. If the payroll did print properly, the remote office software generates an audit record file and sends it to the corporate office in step 544. The audit record file provides a full and comprehensive audit trail of all payroll checks or other documents printed. The audit record file contains unique identifiers for each transaction that can incorporate very detailed information about the transaction. The identifier can be produced by combining alphanumeric characters which reference the desired information. In the payroll case, the identifier for a check can include a transaction number and the number of the check. Fields can also be added to indicate the time of printing, the location of the printing, the user who has ordered the printing, or even the characters used in the watermark on the checks. The combination of the identifier, the confirmation messages from the remote locations as to which documents have been printed, and the voided documents which are returned to the main office provide complete information about the printing of documents under the system. The system can provide up-to-the minute information about which documents have been printed, which blank forms remain in inventory, which documents have been voided, and which documents have been printed out of sequence. The remote office software can also provide a complete and confidential event log of all user activity, by monitoring its use and saving the data.

Finally, in step 546, the remote office software clears the print buffer and deletes the payroll file. Thus, this embodiment provides a high degree of security for the data used for printing. Access to the data is limited. A user must login and present an iKey. Further, the data is stored primarily in encrypted form. It is decrypted only shortly before printing, and it is deleted from the remote office computer immediately after printing. The central office software controls the entire process, and an administrator can grant or deny access to data, the changes to take place immediately.

In alternative embodiments, the components of FIGS. 3, 4 and 5 dealing with the printing of forms and other documents can be omitted, including the components that establish print protocols and the components that deal with reporting the results of printing. An alternative embodiment can provide for the viewing, but not the printing, of transmitted data on the remote computer.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A system for the secure transmission of computer data, comprising:
a source computer;
a receiving computer;
a communications link between the source and receiving computers for transmission of data;
wherein the source computer is configured to encrypt data and to transmit the data to the receiving computer over the communications link; and
wherein the receiving computer is configured to decrypt the data in response to user authentication to access the data transmitted to the receiving computer.

2. The system of claim 1, further comprising:
a printer connected to the receiving computer; and
wherein the receiving computer is further configured to send to the printer at least one document incorporating at least some of the decrypted data.

3. The system of claim 1, further comprising:
a security token; and
wherein the system is configured to deny a user access to the data on the receiving computer until the system verifies the digital certificate contained on the security token.

4. The system of claim 1, wherein the system is further configured to deny a user access to the data transmitted to the receiving computer until the receiving computer verifies a user login indicia and password.

5. The system of claim 1, further comprising a biometric authentication device connected to the receiving computer, the system further configured to deny a user access to the data on the receiving computer until the biometric authentication device verifies his identify.

6. The system of claim 5, the system configured to deny a user access to the data on the receiving computer until it verifies his login and password.

7. The system of claim 2, further comprising security paper, the system further configured for the security paper to be inserted into the printer before the printing of the document.

8. A method for the secure transmission of computer data, comprising the steps of:
encrypting data on a source computer;
transmitting the data to a receiving computer; and
decrypting the data on the receiving computer; wherein a user must provide authentication to access the encrypted data on the source computer, a user must provide authentication to access the data on the receiving computer, and the data on the receiving computer is not decrypted until a user has been granted access.

9. The method of claim 8, further comprising the step of printing from the receiving computer a document incorporating at least some of the decrypted data.

10. The method of claim 8, wherein the step of decrypting the data further comprises decrypting the data in response to receipt of a security token authorizing access to the receiving computer.

11. The method of claim 8, wherein the step of decrypting the data further comprises decrypting the data in response to verification of a user login indicia and password.

12. The method of claim 8, wherein the step of decrypting the data further comprises decrypting the data in response to verification of a user login indicia and PIN.

13. The method of claim 8, wherein the step of decrypting the data further comprises decrypting the data in response to verification of the identify of the user by a biometric device.

14. The method of claim 8, wherein the step of decrypting the data further comprises decrypting the data in response to the provision by the user of two forms of authentication.

15. The method of claim 8, wherein the step of encrypting the data further comprises encrypting the data by using different levels of encryption for different portions of a document.

16. The method of claim 9, wherein the step of transmitting the data further comprises transmitting the data to the receiving computer under the control of software on the source computer; wherein the step of printing a document further comprises printing the document when software on the source computer makes the data incorporated in the document available for printing; and wherein the step of decrypting the data further comprises decrypting the data when accessed by users to whom software on the source computer grants access.

17. The method of claim 9, further comprising the step of deleting the data from the receiving computer after the printing has been attempted, whether successfully or unsuccessfully.

18. The method of claim 17, further comprising the step of deleting the data from the print buffer after the printing has been attempted.

19. The method of claim 9, wherein the step of printing a document further comprises printing the document onto security paper.

20. The method of claim 9, wherein the step of printing a document further comprises printing security features onto the document.

21. The method of claim 9, further comprising the step of transmitting verification of print.

22. The method of claim 9, further comprising the step of generating a document identifier, wherein the document identifier contains detailed information about the transaction.

23. The method of claim 9, further comprising the step of producing a full and complete audit trail of all documents printed.

24. The method of claim 9, wherein the step of printing a document further comprises printing a payroll check.

25. The method of claim 9, wherein the step of printing a document further comprises printing a medical record.

26. The method of claim 9, wherein the step of printing a document further comprises printing a medical test result.

27. The method of claim 9, wherein the step of printing a document further comprises printing a document generated in the process of the application for motor vehicle title, registration and taxation documents.

28. A method of encrypting data, comprising the steps of:
dividing the data into at least two portions;
encrypting the portions; and
creating an index file which describes the portions into which the data was divided and the methods of encryption used to encrypt the portions of the data; and wherein not all portions of the data are encrypted by the same encryption method.

29. The method of claim 28, wherein the step of dividing the data into portions further comprises dividing the data into portions based upon the degree of security required.

30. The method of claim 28, wherein the step of encrypting the first portion further comprises:
encrypting the first portion by the method used to encrypt the second portion; and
encrypting the resulting encrypted first portion by an additional encryption method.

31. The method of claim 30, wherein the step of encrypting the second portion further comprises encrypting the second portion by using at least one encryption key, and wherein the step of encrypting the first portion by an additional method further comprises encrypting the first portion by using at least one additional encryption key.

32. The method of claim 31, further comprising the steps of:
generating a first encryption key;
generating a random number; and
multiplying the random number by the first encryption key to produce a second encryption key;
wherein one of the at least one additional encryption keys consists of the second encryption key.

33. A computer program product for the secure transmission of computer data, the computer program product having a medium with a computer program embodied thereon, the computer program comprising:
computer code for encrypting data on a source computer;
computer code for transmitting the data to a receiving computer; and
computer code for decrypting the data on the receiving computer; wherein a user must provide authentication to access the encrypted data on the source computer, a user must provide authentication to access the data on the receiving computer, and the data on the receiving computer is not decrypted until a user has been granted access.

34. The computer program product of claim 33, further comprising computer code for printing from the receiving computer a document incorporating at least some of the decrypted data.

35. The computer program product of claim 33, further comprising computer code for decrypting the data in response to receipt of a security token authorizing access to the receiving computer.

36. The computer program product of claim 33, further comprising computer code for decrypting the data in response to the provision by the user of two forms of authentication.

37. The computer program product of claim 33, further comprising computer code for encrypting the data by using different levels of encryption for different portions of a document.

38. The computer program product of claim 34, further comprising computer code for transmitting the data to the receiving computer under the control of software on the source computer; computer code for printing the document when software on the source computer makes the data incorporated in the document available for printing; and computer code for decrypting the data when accessed by users to whom software on the source computer grants access.

39. The computer program product of claim 34, further comprising computer code for printing the document onto security paper.

40. The computer program product of claim 34, further comprising computer code for printing security features onto the document.

41. The computer program product of claim 34, further comprising computer code for transmitting verification of print.

42. The computer program product of claim 34, further comprising computer code for generating a document identifier, wherein the document identifier contains detailed information about the transaction.

43. The computer program product of claim 34, further comprising computer code for producing a full and complete audit trail of all documents printed.

44. A computer program product for encrypting data, the computer program product having a medium with a computer program embodied thereon, the computer program comprising:
computer code for dividing the data into at least two portions;
computer code for encrypting the portions; and
computer code for creating an index file which describes the portions into which the data was divided and the methods of encryption used to encrypt the portions of the data;
wherein not all portions of the data are encrypted by the same encryption method.

45. The computer program product of claim 44, further comprising computer code for dividing the data into portions based upon the degree of security required.

46. The computer program product of claim 44, further comprising computer code for encrypting the first portion by the method used to encrypt the second portion; and
computer code for encrypting the resulting encrypted first portion by an additional encryption method.

47. The computer program product of claim 46, further comprising:
computer code for encrypting the second portion by using at least one encryption key; and
computer code for encrypting the first portion by an additional method further comprises encrypting the first portion by using at least one additional encryption key.

48. The computer program product of claim 47, further comprising:
computer code for generating a first encryption key;
computer code for generating a random number; and
computer code for multiplying the random number by the first encryption key to produce a second encryption key;
wherein one of the at least one additional encryption keys consists of the second encryption key.
